(19) United States
(12) Patent Application Publication
(10) Pub. No.: US 2025/0361917 A1
(43) Pub. Date: Nov. 27, 2025

(54) METHOD FOR THE PREPARATION OF FRICTION MATERIALS, IN PARTICULAR FOR THE MANUFACTURE OF BRAKE PADS, AND ASSOCIATED BRAKE PAD

(71) Applicant: ITT Italia S.R.L., Milan (IT)

(72) Inventors: Francesco VANNUCCI, Barge (IT); Sandro DE DOMINICIS, Barge (IT); Agustin SIN XICOLA, Barge (IT); Alberto CONTE, Barge (IT); Paolo COLOMBO, Barge (IT); Useche DOS SANTOS INCHAUSPE, Barge (IT)

(73) Assignee: ITT Italia S.R.L., Milan (IT)

(21) Appl. No.: 18/872,517

(22) PCT Filed: Jun. 9, 2023
(86) PCT No.: PCT/IB2023/055960

§ 371 Date: Dec. 6, 2024

(30) Foreign Application Priority Data
Jun. 10, 2022 (IT) 102022000012338

(51) Int. Cl. F16D 69/02; C04B 12/00; C04B 111/00

(52) U.S. Cl. CPC F16D 69/028; C04B 12/005; C04B 2111/00362

(57) ABSTRACT

Method for obtaining a friction material for a brake pad wherein a wet paste formed by mixing an alkaline silicate solution with metakaolin is spread on a support in a layer or tape and subsequently subjected to a thermal treatment to form a geopolymer aggregate; wherein the thermal treatment consists in drying the wet paste to a completely dried or almost completely dried geopolymer aggregate having a moisture content lower than a desired moisture content in the final geopolymer; and wherein the completely dried or almost completely dried geopolymer is ground to a powder, which is then re-wetted to a desired moisture content by addition of water or of a hydrated salt.

### CROSS-REFERENCE TO RELATED APPLICATIONS

This patent application claims priority from Italian Patent Application No. 102022000012338 filed on Jun. 10, 2022, the entire disclosure of which is incorporated herein by reference.

### TECHNICAL FIELD

The present invention relates to a method for the preparation of a friction material, specifically for the manufacture of brake pads. The invention also relates to an associated friction material and to a brake pad manufactured using the friction material made by such a method.

The friction material of the invention is specifically intended for the manufacture of non-asbestos friction layers/blocks for friction elements such as braking elements, i.e. vehicle brake pads or shoes, and/or friction discs, having performance similar to or better than those belonging to the NAO (“Non-Asbestos Organic friction material”), “Low Steel” and “Semi-met” classes of friction materials.

### TECHNICAL BACKGROUND

Published application EP3128201 in the name of the same Applicant, the whole content of which is incorporated herein by reference for the necessary parts thereof, discloses a method for obtaining a binder for brake pads, constituted for at least the 90% by a geopolymer, as well as an associated friction material and a brake pads.

In EP3128201 the binder is obtained by dry grinding caustic soda flakes and subsequent dry mixing of the soda powder with kaolin. This procedure, though being chemically efficient, involves a not-insignificant series of potential safety risks to operators. In particular, the dry grinding of caustic soda is a high-risk process and may produce very fine and volatile sodium hydroxide powders, highly caustic and irritating, which could be accidentally inhaled by operators when the grinder is opened to unload the product, for example, or during cleaning of the machine. Moreover, during grinding, or subsequently to it, soda powders can absorb a significant and not controlled quantity of moisture from the environment. This uncontrolled residual moisture is retained by the soda in subsequent mixes with kaolin and if too high may be released in the form of a vapor during the hot molding of brake pads, leading to severe production problems with the layers/blocks of finished friction material, which tend to flake and crack.

In order to overcome this problem, EP3841311 still in the name of the same Applicant, the whole content of which is also incorporated herein by reference for the necessary parts thereof, discloses a similar process but working with metakaolin instead of kaolin, and with an aqueous sodium silicate solution with a minimum of sodium hydroxide, which can in any case be used as a reactant.

According to EP3841311, other sources of aluminum silicates can be used in addition to metakaolin, such as kaolin or fly ash. However, kaolin has long reaction times, while one negative aspect of fly ash is the fact that suppliers do not provide unvarying composition over time. Accordingly, metakaolin is preferred.

Still according to EP3841311, other raw materials may be used, e.g. a generic source of silica, such as quartz, or colloidal silica dissolved in a basic sodium or potassium hydroxide solution, under suitable conditions.

In any event, EP3841311 teaches a process wherein a wet mortar, produced by adding the above-mentioned solution of alkali silicate to metakaolin by mechanical mixing, is subsequently dried through an atmospheric pressure drying process, which can also be conditioned, until vacuum state is achieved (i.e., values equal to or greater than 0.018 mBar), with temperatures from 20° to 300° C. The drying is normally done by atmospheric pressure at a temperature from 80° to 200° C., to obtain a dried product in form of a tape having a loss of weight of 5% to 40% from the original weight and a related residual moisture less than 30% in final weight. This product is then ground until sizes less than or equal to 800 microns, preferably less than 400 microns, and the resulting powdered material is used as a binder for the production of mix/compositions for brake pads similar to those as disclosed in EP3128201.

Subsequent tests carried out by the technical people of the Applicant, both in laboratories and by test drive on real vehicles, have now shown that the content of residual humidity in the geopolymer powder used as the raw material binder in friction compositions has to be tuned with extreme precision, i.e. it is not sufficient that the residual moisture be any value less than 30% w (in weight), but it has to stay within prefixed ranges, which have been proved to be extremely difficult to be met operating with the process of EP3841311, which may possibly cause in production a fair large amount of scrap material which, moreover, cannot be recycled, with a net economic and energy loss.

### SUMMARY OF THE INVENTION

The object of the invention is to provide a method for the manufacture of friction layers/blocks for friction elements such as braking elements, e.g. vehicle brake pads or shoes, and to prepare the related friction material and a respective inorganic binder which are free of the aforementioned problems of the methods of both EP3128201 and EP3841311, and which therefore facilitate the obtaining of friction materials and associated brake pads resistant to the heat generated during braking, simultaneously providing satisfactory braking performance, optimal tribological characteristics and easiness to be manufactured.

It is also an object of the invention to provide a manufacturing method that allows easy recycling and recovery of geopolymers accidentally produced with less than satisfactory standard.

The invention therefore relates to a method to produce friction layers/blocks for friction elements such as braking elements, e.g. vehicle brake pads or shoes, as defined in the appended claims.

The invention also relates to an associated binder, as well as a friction material containing such binder, and to an associated friction element, particularly brake pads or shoes, possessing a friction layer or block produced with the method of the invention.

In particular, the friction material according to the method of the invention includes as its component materials: inorganic and/or organic and/or metallic fibers; a binder that is almost entirely or completely and exclusively constituted by a geopolymer or by a mix of geopolymers; at least one friction modifier or lubricant, e.g. including sulfurs and/or a carbonic material or nanomaterial; and at least one inorganic or metallic filler or abrasive, wherein, however, the principal abrasive work in the friction material of the invention is done by the geopolymeric matrix of the pads generated by the binder.

Henceforth, “binder almost entirely constituted by a geopolymer” refers to a binder for friction elements in which a geopolymer or a geopolymer composition or mix constitutes at least 90% in weight of the total quantity of binder present.

The geopolymeric binder is, preferably but not necessarily, present in the composition of friction material according to the invention in a quantity equal to or greater than 5% in weight, or even more preferably comprised between 20% and 60% in weight, calculated on the total volume of the friction mix/composition. In fact, experiments have shown that with too small a quantity of inorganic binder, depending on the type of geopolymer used as a binder and the nature of the other materials used in the composition, the mechanical characteristics necessary for its use as a friction material cannot be achieved.

The friction material according to the method of the invention is therefore almost completely or totally lacking organic binders (which may be present at maximum in a quantity equal to or less than 10% in weight) and for this reason cannot be subject to heat degradation through oxidization at high temperatures, e.g., greater than 300° C., and up to beyond 600° C.

The geopolymeric binder produced according to the method of the invention and used in the friction material according to the invention as the single and principal binder and, therefore, prevalent (i.e., making up at least 90% of the total binder present), in the complete or near-complete absence of traditional organic binders, is obtained through a chemical reaction starting from inorganic precursors such as SiO₂ and Al₂O₃, and specifically using commercial sodium (and/or potassium) silicate, for example from the company “PQ Corporation—Holland”, possibly with the addition of a small quantity of sodium or potassium hydroxide (it also works in any case with a near-complete absence of hydroxide), and commercial metakaolin, for example, metakaolin obtained through the high-temperature calcining of kaolin from the company “Imerys Refractory Minerals—Argical-M 1200S”, metakaolin containing in weight approximately 55% SiO₂ and 39% Al₂O₃, plus Fe₂O₃, TiO₂, K₂O, Na₂O, Cao, and MgO impurities, which is generally assumed to have the following general chemical formula:

Al₂O₃·2SiO₂

The inorganic geopolymeric binder according to the invention may be prepared in pre-mixed form and then joined as such to all the other component materials of the mix of friction material, preferably in a Loedige mixer or in any of the other mixers commonly used for friction materials, e.g. Eirich mixer. The unfinished compound thus obtained then undergoes a molding process to produce the desired friction element, e.g., brake pads or blocks.

According to a preferred embodiment of the invention, however, it is instead prepared during the mixing step of the whole friction composition, to give rise directly to the raw friction compound to be subsequently molded in a block of friction material having the desired properties.

### Synthesis of Geopolymeric Binder

Similar to the method of EP3841311, the geopolymeric binder to be used in the friction compositions for braking elements is prepared from metakaolin which is made to react with an aqueous solution of caustic soda and/or potash, with the addition to the caustic solution of sodium disilicate, bringing to the formation of an amorphous geopolymer, which may be converted if necessary into an at least partially-crystalline form through further thermal treatment only.

The following descriptor will make reference to sodium compounds only without losing for this reason in generality, since it is evident for the skilled person that the same technique may be used also with reference to potassium compounds.

A basic aqueous sodium silicate solution is first formed (e.g. by addition of caustic soda), dissolving any form of sodium silicate in water, with the possible addition of commercial soda pellets. Metakaolin is then added to this basic aqueous solution, all at once or gradually while mixing, or, vice versa, the basic soda and silicate solution is gradually added to the metakaolin powder, until a homogeneous paste is obtained with a relatively high SiO₂/Al₂O₃ ratio, kept in the range/interval between 3 and 10, i.e., having “x” being the molar ratio SiO₂/Al₂O₃, the valid ratio must be:

$$3 < x < 10$$

This wet paste, similar to a slurry, is taken from the mixer and undergoes a step of forming and drying in any atmospheric regime (so even under vacuum) in any temperature regime up to 300° C., using an appropriate forming and drying system, preferably a tape casting device, such as that one shown (schematically only) in the published Italian patent application No. 102020000015202.

As already disclosed in this published Italian patent application, the mixing of the silicate solution and the metakaolin may include one mixing at a speed between about 500 rpm and about 1000 rpm and for a time between about 1 minute and about 20 minutes.

The mixing of the silicate solution and the metakaolin may be carried out at a temperature between about 20° C. and about 40° C.

Thereafter, the wet paste/mortar/slurry so obtained and exiting from the mixer is spread on a support to form a layer of homogeneous thickness and subjected to a thermal treatment in which it is dried to obtain a tape made of dried/semi-dried geopolymeric material.

According to IT102020000015202 the dried tape may have a moisture content of any value comprised between 0% w to 20% w and a thickness between about 0.1 mm and about 2 mm.

The support may consist of paper, a plastic film or a steel sheet. For instance, the support may consist in Sappi® paper or in a Coveme® film.

More generally, according to the present invention, the support, e.g. in the form of an endless belt conveyor, may be made of specific material not sensitive to the basic atmosphere, suitable for neutral or alkaline pastes/mortars, e.g. Mylar or other types of materials suitable for neutral/alkaline pastes/mortars. During forming (in this case, it is also suitable tc apply mechanical stress with high shear stress to the paste) and drying of the paste into a tape, the geopolymerization reaction occurs, in which the metakaolin is dissolved in the alkaline sodium silicate solution. The oligomers formed then condense together to create the 3D geopolymer network.

The drying step is preferably carried out in a controlled temperature oven (single or multistage oven), where the controlled temperature oven can have a temperature profile adapted by means of a control device. The drying step may be carried out in a discontinuous or continuous manner. When carried out in a continuous manner, a tunnel oven/furnace may be used crossed by the layer of wet paste spread on the support.

According to a first main feature of the invention, and unlike what it is taught in IT102020000015202, instead of trying to dry the wet paste in a controlled manner to reach any desired moisture content already at the exiting of the oven, the drying treatment, preferably conducted at a temperature between 10° and 250° C., is carried out to obtain a completely dried or almost completely dried aggregate residue, consisting of an amorphous geopolymer having a nil or very low moisture content, equal to zero or anyway lower than a desired final moisture content.

Thereafter, according to a second main feature of the invention, to be taken in combination with the first feature as above, this completely dried or almost completely dried geopolymer is re-wetted in a suitable mixer in order to reach the desired moisture content.

Such a desired moisture content, according to a further aspect of the invention, is to be comprised within very narrow and precise ranges. In particular the final moisture content of the geopolymeric binder of the invention is to be comprised between 4% w and 16% w of the total weight of the geopolymer.

It has been experimentally proved, in fact, that only within such a specific and restricted interval of humidity of the amorphous geopolymer it is possible to obtain a friction material which is easily moldable in blocks of sufficient strength and resilience and, at the same time, giving rise to blocks/layers substantially free of cracks or defects and having the braking performances needed.

Therefore, since the moisture content admitted for the geopolymer at the mixing stage (i.e. in the step wherein the complete friction material mix/composition is obtained), according to the present invention, is from 4% w to 16% w, the expression “completely dried or almost completely dried aggregate” means a geopolymer aggregate exiting the drying stage/step having a moisture content equal to about zero or anyway below a value included in the above interval of 4-16% w depending on the desired final moisture content, in such a manner that it is possible to re-wet the geopolymer to the desired moisture content adding to it, directly or indirectly, a substantial amount of water. For “substantial” it is to be intended, here and below, a final amount of added water/moisture of the order of “n” % w (wherein “n” may be, e.g., from about 1 to about 16).

According to the invention, the dried/almost dried aggregate in the shape of a tape exiting the oven and formed by an amorphous geopolymer is ground and reduced to powder, using any suitable grinding systems, preferably a ball grinder or jar mill or hammer mill, until granulometry of less than 600 microns is obtained, preferably less than 400 microns.

Thereafter, according to the invention, the so obtained powder, irrespective of its moisture content, is re-wetted in order to reach the desired moisture level within the aforementioned range of 4% w-16% w.

According to different embodiments of the invention, the re-wetting process may be carried out either before the final mixing phase for obtaining the desired friction material, wherein the geopolymeric powder is mixed together with the other component materials of the friction material to be obtained, or during this very same final mixing step, i.e. while the raw (not yet molded) friction material is prepared by mixing together the various components thereof.

This second embodiment may be preferred.

According to different embodiments of the invention, the re-wetting process may be carried out either by adding to the powdered and dried geopolymer a required amount of liquid water, or by adding to it a calculated amount of a salt having a chemical and/or physical water content, e.g. hydrated salts.

According to a further aspect of the inventions, a suitable salt to re-hydrate the dried or almost dried geopolymer may be selected from the group, exemplificative but not exhaustive, consisting in: Sodium and/or Potassium Carbonate decahydrate (e.g. Na₂CO₃*10H₂O), Sodium and/or Potassium phosphate tribasic dodecahydrate (e.g. Na₃PO₄*12H₂O), Sodium and/or Potassium sulfate decahydrate (e.g. Na₂SO₄*10H₂O), di-Sodium (or Potassium) tetraborate dehydrate (e.g. Na₂B₄O7*10H₂O), any combination thereof.

Di-Sodium tetraborate dehydrate, though chemically effective, is preferably not to be used for safety reasons, since it is a potentially dangerous product.

In any case, the re-wetting phase could be carried out in all manners, however is preferably carried out during the final mixing of all the component materials of the friction material mix/composition, i.e. the dried or almost dried geopolymer is powdered and then, as such, is used as a component material of the friction material mix provided that a re-wetting component/agent, e.g. liquid water or a hydrated salt, is also added together with (in combination with) it.

The embodiment wherein liquid water as the re-wetting agent is used and is added solely during the final mixing step of the friction material mix/composition, i.e. when all the other component materials of the friction mix are also present, may be preferred, since liquid water also avoid at least partially the possible accidental dispersion of the component materials, especially of the geopolymer, in the environment before/during the mixing stage.

The re-wetted geopolymer is mixed, either after re-wetting or during re-wetting, with the other usual components of friction compositions, such as fillers, lubricants, abrasives, fibers, etc., obtaining a mixture of friction material that is molded as in EP3128201. During molding, simply due to the application of pressure and temperature, the previously-synthesized geopolymer particles consolidate and remain amorphous, resulting in a friction element, typically a brake pad, in which the component materials are dispersed into a matrix constituted solely by amorphous geopolymerized inorganic binder (except for possible limited quantities, less than 10%, of organic binder). According to the invention it has been experimentally proved that in order to let the geopolymer to consolidate properly at this stage/step of the manufacturing process, solely a precise and restricted amount of moisture is to be present in/with the geopolymer, precisely an amount of moisture (direct or indirect—i.e. present in the hydrated salts—water) comprised between 4% w and 16% w and preferably comprised between 8% and 12% by weight, including the two extremes of the above intervals.

The friction elements thus obtained do not produce waste due to cracks or flaking, even using pressure in the order of ters of MPa. The result is a reconsolidation of the powder under molding conditions comparable to EP3841311 and under the normal molding conditions of brake pads, producing braking performance comparable to those of the friction material produced according to the hydrothermal synthesis of EP3841311 and with the material and disc wear from use comparable to that of identical components created according to EP3128201 or EP3841311.

### Molding for Reconsolidation of Geopolymer Powder

The molding of the brake pads obtained with the method of the invention is done by placing the raw compound (friction mix) into a mold which also has a metallic support or backplate, property treated and with or without a known damping/insulating layer, called the “underlayer”, which during the molding stage not only forms the layer or block of friction material, possibly over the underlayer when present, but also achieves adhesion of this layer or block to the metallic support.

The molding is done working at temperatures between 40 and 250° C. and at a pressure from 150 to 2000 Kg/cm2 for a time between 1 and 30 minutes, or preforming the raw compound or mix into a mold and then molding the pre-formed compound on the backplate at a temperature of 40 to 250° C. at a pressure of 150 to 2000 kg/cm2 (14.7-196 MPa) for a period of 3 to 15 minutes.

Alternatively, the raw compound can be molded to obtain the friction material block, which is only then connected to the metallic support or backplate (with or without underlayer), for example using phenolic or silicon-based glue.

### Other Components of the Friction Material

The components of the composition or raw compound of friction material to be produced according to the invention can be the components used in the friction materials already known in the technique, with the sole precaution to completely replace the current organic binders with the inorganic binder obtained with the method as described above, simultaneously reducing the content of abrasives and increasing the content of lubricants.

The friction material obtainable according to the invention is also preferably free of copper and/or its alloys, both in powder and fiber form.

In particular, the component made of fiber may consist of any organic or inorganic fiber other than asbestos, or in any metallic fiber commonly used in friction materials, preferably excluding copper and its alloys. Illustrative examples include inorganic fibers such as glass fibers, wool or rock fiber, wollastonite, sepiolite and attapulgite, and organic fibers such as aramid fibers, polyimide fibers, polyamide fibers, phenolic fibers, cellulose and acrylic fibers or PAN (Polyacrylonitrile), metallic fibers such as steel fibers, stainless steel, aluminum fibers, zinc, etc.

Fibers may be used in the form of short fibers or powder.

The quantity of fiber is preferable between 2% in volume and 30% in volume out of the total volume of friction material and more preferably between 8% and 15% in volume and the fibrous component preferably always includes rock fiber, which has been shown to have a strong affinity with the geopolymers used as binder.

Numerous materials known in the technique can be used as organic or inorganic fillers. Illustrative examples include precipitated calcium carbonate, barium sulphate, magnesium oxide, calcium hydroxide, calcium fluoride, slaked lime, talc, mica.

These can be used alone or in combinations of two or more. The quantities of these fillers is preferably between 2% to 40% in volume based on the total composition of the friction material.

The friction modifier (which could include all or part of the filler) can include, in addition to carbonic materials or nanomaterials such as graphene, an organic filler such as cashew dust, rubber dust, powdered tread rubber, a variety of unvulcanized rubber particles, a variety of vulcanized rubber particles, an inorganic filler such as barium sulphate, calcium carbonate, calcium hydroxide, vermiculite and/cr mica, an abrasive such as silicon carbide, alumina, zirconium silicate, metal sulfide-based lubricant such as molybdenum disulphide, tin sulfide, zinc sulfide, iron and non-ferrous sulfides, metal particles other than copper and copper alloys, and/or a combination of the above.

Abrasives can be classified as follows (the list below is only indicative, not necessarily exhaustive and not limiting):
Mild Abrasives (Mohs 1-3): talc, calcium hydroxide, potassium titanate, mica, kaolin, vermiculite;
Medium Abrasives (Mohs 4-6): barium sulphate, magnesium oxide, calcium fluoride, calcium carbonate, wollastonite, calcium silicate, iron oxide, silica, chronite, zinc oxide;
Strong Abrasives (Mohs 7-9): silicon carbide, zircon sand (zirconium oxide), zirconium silicate, zirconium, corundum, alumina, mullite.

Preferably, but not necessarily, the friction material obtainable according to the invention does not contain strong abrasives but only medium or mild abrasives, since the geopolymer produced as binder already is, in itself, a medium abrasive.

The friction material produced according to the invention may also preferably include graphite, in a quantity between 5% and 15% in volume based on the total composition of the friction material.

The total content of lubricants, according to desired friction characteristics, may be preferably between 4% and 20% of the entire volume of friction material, and can include graphene in particular.

### Curing and Painting

The molded article item (brake pad), which was cured during pressing and generally already usable after this simple press molding, is optionally, when required by the formulation and/or by the design specifications, further post-cured through supplementary heat treatment from 80 to 450° C. for between 10 minutes and 15 hours, then spray- or powder-painted, oven-dried and possibly mechanically processed where necessary to produce the finished product.

The friction material obtained with the method of the invention, both after simple press molding and after possible optional supplementary heat treatment, can be used in applications such as disc brake pads, shoes, and linings for cars, trucks, train cars and various other types of vehicles and industrial machines, or in clutch discs.

### BRIEF DESCRIPTION OF DRAWINGS

This invention will now be described in more detail with reference to non-exhaustive and non-limiting practical examples of implementation thereof and with reference to the figures of the annexed drawings, in which:

FIG. 1 schematically illustrates the sequence of steps of the method of the invention and a possible embodiment of an apparatus to carry out the method of the invention;

FIG. 2 from a) to e) illustrate respective pictures of consolidation samples of the same geopolymer composition prepared with different degrees of humidity, i.e. having different moisture contents;

FIGS. 3 to 5 are graphics showing a comparison of mechanical properties of the same friction material mix/composition including the same geopolymeric composition and obtained with the method of EP3841311 (Reference A) and with the method of the invention using different amounts of liquid water, so having different degrees of humidity/moisture contents, including compressibility (FIG. 3), hardness (FIG. 4) and density (FIG. 5);

FIG. 6 illustrates in a comparative manner and via sequential block diagrams the main steps of a method of production of brake pads according to two different embodiments of the invention and according to the prior art, namely EP3841311, labelled “classical approach”;

FIGS. 7 to 9 are graphics showing a comparison of mechanical properties of the same friction material mix/composition including the same geopolymeric composition and obtained with the method of EP3841311 (Reference B) and with the method of the invention using the same degree of humidity, i.e. having the same moisture content (10% w), obtained via the addition of different hydrated salts, including compressibility (FIG. 7), hardness (FIG. 8) and density (FIG. 9); and

FIGS. 10 to 12 show graphics representing a selection of the most representative parts of the results of the same AK Master braking test carried out on brake pads produced with the prior art friction material according to References A and B and with a friction material according to the method of the invention produced with the same content of moisture/humidity obtained with addition of liquid water (FIG. 10) or with the addition of different hydrated salts/FIGS. 11 and 12), FIG. 10 also including pictures of the brake pads and of the relative braking disk used in the AK Master test and showing the respective degree of wear.

### DETAILED DESCRIPTION

The examples and comparative examples are reported herein for purposes of illustration, and are not intended to limit the invention.

### Apparatus According to the Invention

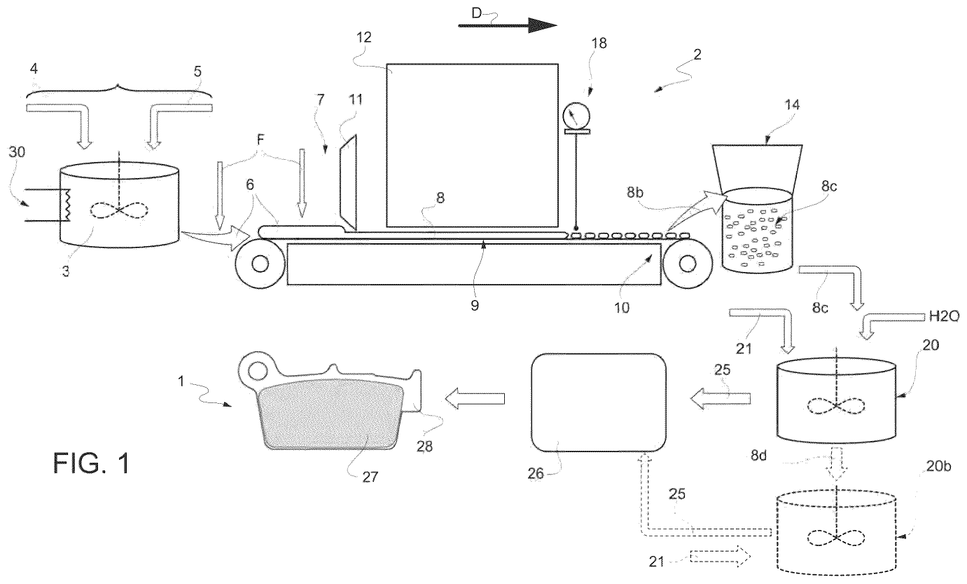

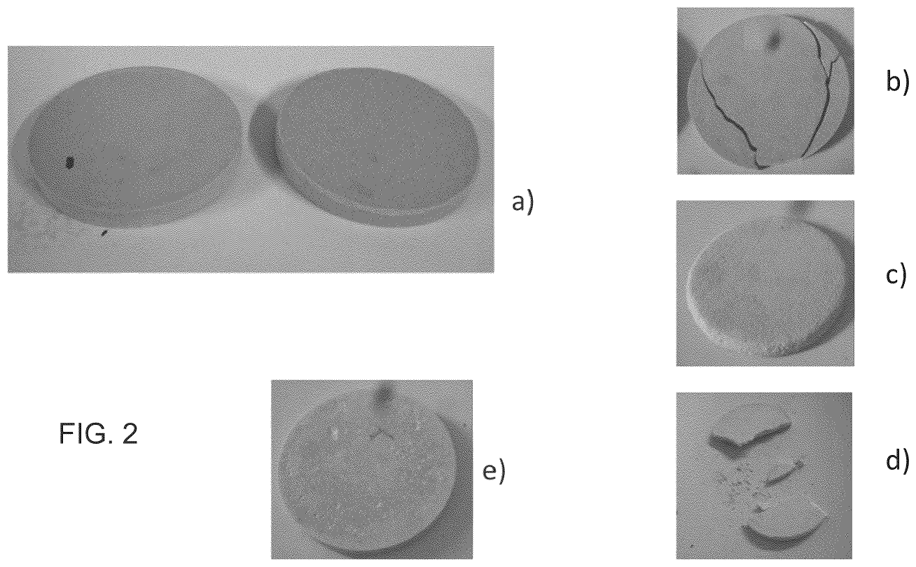

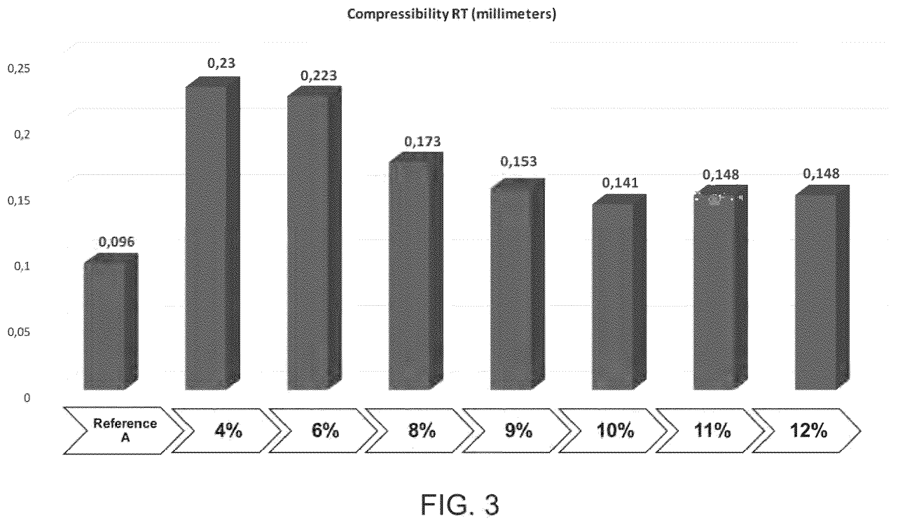

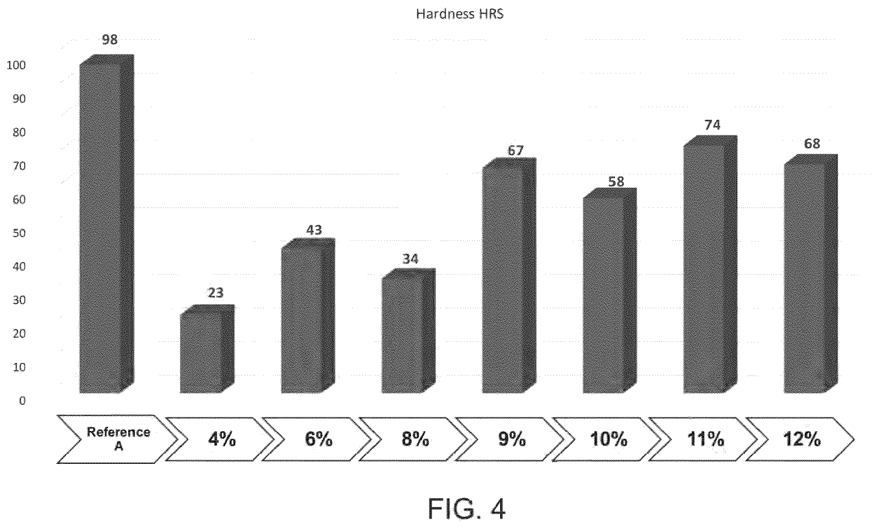

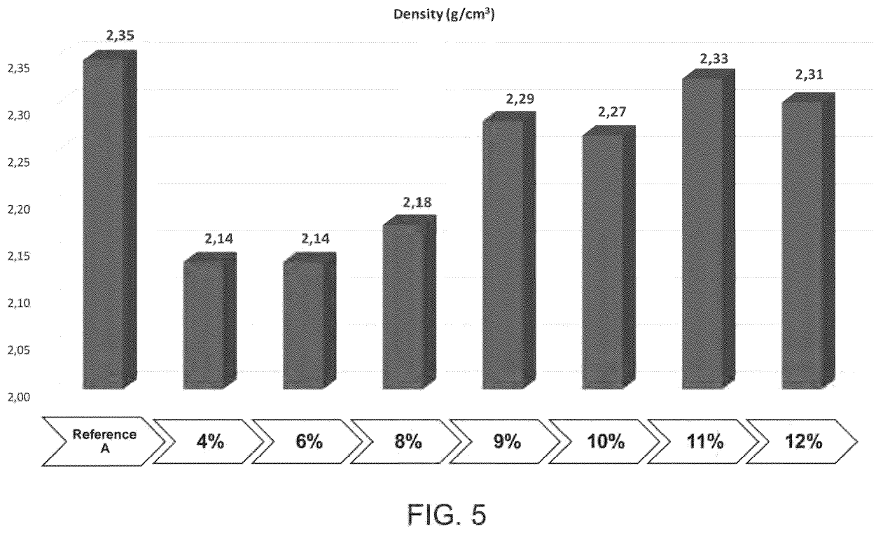

With reference to FIG. 1, it is shown in only a purely schematic way an apparatus or plant 2 configured to carry out the method of the invention to produce a brake pad 1 and also being part of the invention in itself, as well as the associated brake pad 1 obtained with the method carried out by the apparatus 2.

The apparatus or plant 2 may be of a continuous cr batch type, in the non-limitative embodiment shown is of the continuous type, and is configured to carry out in a temporal sequence a number of different operations/steps in a corresponding number of specialized devices, which, in a continuous type plant, are arranged in a physical sequence too as shown in FIG. 1, along a direction D, the apparatus or plant 2 comprising:
A first mixer 3 of any known type, preferably a Dispersion Mixer, to which a caustic silicate solution 4 in water and metakaolin 5 are added and mixed together to obtain a semi-liquid geopolymeric paste/slurry 6; such geopolymeric paste can be formed using e.g. a solution of alkaline silicate such as a solution of sodium silicate, a solution of potassium silicate, a solution of lithium silicate or any other chemically equivalent aqueous solution. Mixer 3 may be equipped with a temperature control system 30 of any known type;
a tape casting machine 7 of any known type configured to cast in form of a layer/tape 8 of substantially uniform thickness the freshly formed geopolymer 6, which layer/tape of geopolymer is made to rest on a support 9; preferably the tape casting machine 7 is equipped with an endless belt conveyor 10 the upper surface of an upper branch of which forms the support 9. The machine 7 is preferably equipped with a blade 11 to reduce the thickness of the layer/tape 8 of geopolymer evenly to any chosen value comprising between 0.2 and 2 mm and with pressing means (not shown) able to press the geopolymeric paste with a prefixed force F;
a hot air furnace or oven 12, which, in the non-limitative embodiment shown, which relates to a continuous tape casting machine 7, is crossed by the conveyor 10 and is preferably a tunnel oven/furnace. The oven 12 is configured, according to an aspect of the invention, to bring the layer/tape 8 of geopolymeric paste/slurry to a completely or almost completely dried condition 8b, where the expression “completely dried or almost completely dried conditions” means a condition in which the geopolymer aggregate exiting from the furnace/over 12 has a moisture content equal to about zero or anyway below a value included in the interval of 4-16% w, depending on the desired final moisture content in the friction material;
a mill 14 (e.g. a ball mill or jar mill, preferably a hammer mill) arranged downstream (with reference to direction D) the oven/furnace 12 and e.g. fed by the conveyor 10, configured to receive the dried or almost dried geopolymer 8b and to crush it in a powder 8c having a prefixed range of granulometry from 1 to 500 micron and preferably comprised between 1-100 micron;
at least an humidity detector 18 arranged downstream of the oven/furnace 12, configured to detect the humidity of the reacted geopolymer when it exit the oven/furnace 12;
a second mixer 20 of any known type (e.g. Loedige or Eirich mixer) arranged downstream the mill 14 and configured to receive the dried or almost dried geopolymer 8b crushed into a powder 8c and a prefixed quantity of water, either in the form of liquid water or of an hydrated salt. The mixer 20 is configured to re-wet the dried or almost dried geopolymer powder 8c to a precise moisture content substantially equal to or lower than the moisture content the reacted geopolymer 8 has at the exit of the casting machine 7. The mixer 20 may also be configured to receive all the other component materials of the friction material to be obtained, schematized in FIG. 1 by the arrow 21. According to a different (and possibly preferred) embodiment, schematized in dotted lines in FIG. 1, the second mixer 20 (which is in this case a Loedige or Eirich mixer) is configured solely to re-wet the powder 8c to a prefixed value of humidity either by direct addition of liquid water or by indirect addition of water by means of addition of hydrated salts, and the apparatus or plant 2 comprises a third mixer 20b arranged downstream mixer 20 and configured to receive a re-wetted, precisely hydrated geopolymer 8d (arrow in dotted lines) from the mixer 20 and all the other component materials 21 of the friction material to be obtained. In both cases, exiting from the mixer 20 (or 20b) is a “green” or “raw” friction material mix/composition 25;
a molding equipment 26 of any known type schematized with a block for sake of simplicity, receiving the “green” or “raw” friction material, mix/composition 25 to mold it in a friction material block or layer 27 having as a binder solely or almost completely a well consolidate matrix of geopolymer. The molding equipment 26 may be configured to mold the block of consolidated friction material 27 directly on a support or backplate 28 to obtain the brake pad 1, or to mold the block 27 of consolidated friction material, which is then applied/attached to support 28 to obtain the brake pad 1.

In this manner, contrary to what disclosed in IT102020000015202, it is not necessary to employ sophisticated humidity sensors and complex control devices in order to provide a geopolymer powder 8c having a desired content of humidity. In fact, it is possible to easily calculate the water/humidity lost by the reacted geopolymer 8 in the oven/furnace 12 knowing its initial humidity and weight and its final weight after drying and so metering with precision the quantity of water (or of hydrate salts) to be added in mixer 20.

Moreover, the tests carried out by the Applicant also demonstrate, as it will be shown in more details herein below, that the consolidation of the geopolymer during the molding step of the friction material in equipment 26 is fairly better, at the same humidity content of the geopolymer, than in the case the re-wetting step in mixer 20 is not carried out and the required moisture content in the geopolymer is obtaining by means of a precise and strict control of the drying step in oven 12 according to IT102020000015202, which require a continuous monitoring of the instant humidity of the geopolymer under treatment and which proved to be anyway not easy to be obtained also due to the inevitable thermal inertia of the whole drying apparatus and of the mass of the geopolymer under treatment.

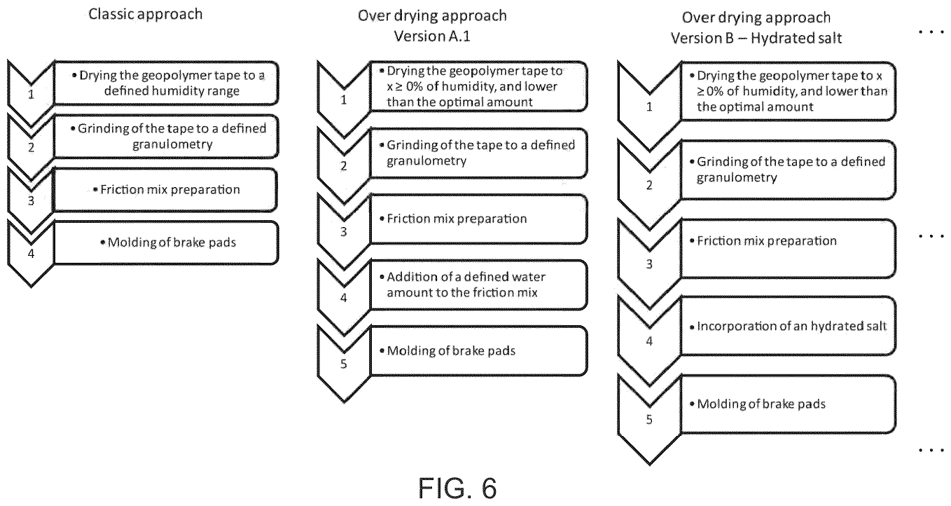

With reference to FIG. 6, it is shown for a better clarity a comparison between the method of the prior art according to EP3841311 and IT102020000015202 (labelled “classic approach”) and two different possible embodiments of the present invention, labelled “version A.1” and “version B”, all configured to obtain at the end a brake pad 1 having a geopolymer as the unique or prevalent binder.

As it is clearly shown in FIG. 6, the classic method of the prior art, after having obtained a geopolymer according to anyone of the approaches disclosed in EP3841311, comprises four main steps: a first step wherein the synthetized geopolymer is dried to a tape of a defined humidity range; a second step wherein the tape of geopolymer is ground to a definite granulometry; a third step wherein a friction material mix or composition is prepared in any suitable traditional manner using the ground geopolymer as a binder; and a fourth step wherein the friction material mix is molded to form a brake pad 1 (or a friction material block 27 to be then joined to a backplate 28 to obtain the brake pad 1).

In a first embodiment of the method of the invention, labelled A.1, after having obtained a geopolymer according to anyone of the approaches disclosed in EP3841311, five main steps are carried out instead of four:
a first step wherein the synthetized geopolymer is dried to a moisture content “x”, wherein x≥0% of humidity, and anyway lower than the optimal amount (so lower than the defined humidity range of the classic method);
a second step wherein the dried or almost dried tape of geopolymer is ground to a definite granulometry;
a third step wherein a friction material mix or composition is prepared in any suitable traditional manner adding to the dried or almost dried and ground geopolymer all the other component materials of the desired friction material mix;
a fourth step wherein a certain amount of liquid water calculated in order to obtain a desired and precisely defined humidity of the geopolymer is added to the friction material mix prepared in the third step: in this manner a dried geopolymer and water are used in combination, as the binder, both such components being generally added in the same mixer together with the other component materials of the desired friction material mix;
a fifth step wherein the friction material mix is molded to form a brake pad 1.

In a second embodiment of the method of the invention, labelled B, after having obtained a geopolymer according to anyone of the approaches disclosed in EP3841311, four main steps are carried out:
a first step wherein the synthetized geopolymer is dried to a moisture content “x”, wherein x≥0% of humidity, and anyway lower than the optimal amount (so lower than the defined humidity range of the classic method);
a second step wherein the dried or almost dried tape of geopolymer is ground to a definite granulometry;
a third step wherein a friction material mix or composition is prepared in any suitable traditional manner adding to the dried or almost dried and ground geopolymer
   a) all the other component materials of the desired friction material mix AND, in combination,
   b) a defined amount of an hydrated salt—this sub-step b) is equivalent to the fourth step of embodiment A.1;
a fourth step wherein the friction material mix is molded to form a brake pad 1.

A further embodiment of the method of the invention is also possible, similar to embodiment A.1 and which may be labelled as embodiment A.2 (not shown for sake of simplicity), wherein five steps are carried out again: the first and second steps being identical to the corresponding ones of embodiment A.1; the third step consisting in the addition of a defined water amount of liquid water to the dried or almost dried geopolymer powder in a first mixer so as to obtain a wetted geopolymer powder; the fourth step consisting in the preparation of a friction material mix or composition in a second and different mixer, using the wetted geopolymer powder as binder; and the fifth step consisting in molding the friction material mix to form a brake pad 1.

### Method According to the Invention—Operational Example

A silicate solution (produced by mixing water, hydroxide and solid silicate supplied by PQ corporation) with an appropriate composition and commercial metakaolin are mixed with a solution/metakaolin weight ratio between 1 and 10 (inclusive) for a Si/Al molar ratio in the range 1<x<10; preferably this range can vary from 2 to 6. Different ratios with a higher Al or Si content are also possible; however, the experimental results and theoretical calculations lead to the conclusion that the invention operates with maximum efficiency with a Si/Al ratio between 2 and 6.

The caustic silicate solution and metakaolin are mixed through mechanical agitation, to obtain the formation of a homogeneous paste.

The paste thus obtained is spread onto a plastic mat using the “Tape Casting” technique and dried in temperatures between 70-250° C. and under atmospheric pressure, in a time ranging between 1′ (minutes) and 90′ (minutes), depending on the power of the oven used, to reduce the weight of the mixture by up to 10-40% of the original weight, and transform it into pure amorphous geopolymer.

The dried silicate-metakaolin geopolymeric system is removed from the drier and ground with a ball grinder. Its final water content is calculated by considering the maximum quantity of water that the system is able to lose, to which corresponds a powder moisture of 0%.

The geopolymer powder so produced is re-wetted to a precise and desired content of humidity comprised between 4% w and 16% w in a Loedige or Eirich mixer (or other mixers) by adding an appropriate quantity of liquid water and the binder thus produced in hydrated powder form is added to other raw materials required by the friction material mix or composition selected for dry mixing, using a known mixer, for example Loedige or Eirich.

The mix or composition of the “green” friction material thus obtained may be hot molded, under pressure, to obtain a series of brake pads.

### Molding

The molding stage is done by placing the raw or “green” compound and possibly a metallic support with a possible underlayer into a mold (known and not illustrated for simplicity) which is heated to a temperature between 6° and 250° C., submitting the raw compound to a molding pressure between 150 and 2000 Kg/cm2 for a time between 1 and 15 minutes, or pre-forming the raw compound 11 in a mold and then molding the pre-formed compound onto the metallic support, working at a temperature between 10° and 250° C. and with a molding pressure between 150 and 2000 kg/cm2 for a period between 1 to 15 minutes.

Alternatively, the raw compound can be molded without a metallic support, so as to obtain only a block of friction material, which is then subsequently glued in a known manner to the metallic support, whether or not it has an insulator/dampener layer (known) or underlayer, using phenol- or silicon-based glues, e.g., pressing the block of friction material against the metallic support with the possible underlayer, operating at a temperature of 180° C. for 30 seconds.

In any case, the molding pressure must always be greater than the water saturation pressure at the molding temperature.

At the end of the process described above, an asbestos-free friction material is thus obtained, including as component materials inorganic and/or organic and/or metallic fibers, at least one binder, at least one friction modifier or lubricant, and at least one filler or abrasive, where the binder is constituted at least 90% by a silica-aluminum geopolymer perfectly consolidated.

The component materials of the raw compound are added to the inorganic binder in appropriate quantities such that the total quantity of inorganic geopolymeric binder is preferably but not necessarily equal to or greater than 20% in weight and not greater than 60% in weight of the entire volume of friction material and even more preferably equal to about 47% in weight.

After having obtaining the binder, but before the curing stage/step (which normally coincides with the molding stage) to the friction material composition are not added as component materials thereof any asbestos or derivatives, or copper or its alloys; therefore the friction material obtained according to the invention is substantially free of or nearly free of organic binders, is substantially free of copper or its alloys and/or fibers of copper or its alloys and, preferably but not necessarily, is substantially free of strong abrasives, where, here and henceforth, the term “substantially free of” means that the materials indicated may at most be present as impurities; the at least one abrasive contained in the friction materials according to the invention is therefore, preferably but not necessarily, a medium or mild abrasive; where such terms refer to the following classification:
Mild Abrasives (with hardness of Mohs 1-3): e.g. talc, calcium hydroxide, potassium titanate, mica, vermiculite, kaolin;
Medium Abrasives (with hardness of Mohs 4-6): e.g. barium sulphate, magnesium oxide, calcium fluoride, calcium carbonate, wollastonite, calcium silicate, iron oxide, silica, chromite, zinc oxide;
Strong Abrasives (with hardness of Mohs 7-9): e.g. silicon carbide, zircon sand (zirconium oxide), zirconium silicate, zirconium, corundum, alumina, mullite.

The ratio in volume between the lubricants and the abrasives contained in the friction material to be formed is preferably selected between 1:1 and 1:4 (for comparison, this ratio is generally 1:8 or more in known friction materials with organic binder).

Furthermore, the starting raw materials for obtaining geopolymeric binder are selected such that the inorganic geopolymeric binder in the friction material according to the invention has a SiO₂/Al₂O₃ ratio between 3 and 10 and an SiO₂/Na₂O ratio between 3 and 10. The densification of the geopolymer powder is obtained during molding.

### Example 1—Comparative Production of Binders

115.7 gr metakaolin from the company “Imerys Refractory Minerals” are mixed with 300.0 gr of aqueous solution of 139.4 g sodium silicate (as already indicated, potassium silicate would also work) in any form, in this case from the company “PQ Corporation—Holland” and 1.51 g caustic soda in pellets, previously prepared, over a time varying from 5′ to 45′, at a speed of 800 rpm, using a drill agitator along with a specific mixing whisk for medium-high viscosity fluids. The wet paste obtained from mixing the metakaolin with the sodium silicate—caustic soda solution is spread upon a sheet of Mylar, specific for wet and alkaline pastes/slurry using the following parameters: thickness of spread paste between 0.1 and 3 mm.

Thereafter, multiple samples are prepared by drying the wet spread paste at temperatures between 40° and 250° C., sheet sizes between A3 and A4, drying time variable between 10′ and 90′. In particular it is prepared a reference sample having a controlled humidity of 12% w and a plurality of samples fully dried to substantially 0% w humidity.

The semi-dried and completely dried sample binders in solid aggregate form are then separately detached from the sheets and ground with a ball grinder rotating at 275 turns/min, for 14 hours, to bring the granulation of the product to obtain a powder of granulometry of about 200 microns.

The semi-dried sample at 12% w humidity is used as such, while the completely dried samples are re-wetted at different degrees of humidity by addition of liquid water. The amount of water added to the dry geopolymer (in the following also indicated as “GP”) powder was calculated to meet partially or completely the amount of water lost during drying. GP powder and water were mixed in a mechanical agitator, inside PE containers, at 20 Hz for 10 minutes.

An homogenous wet powder was obtained, weighted and pressed with the standard parameters: 150° C.-20 MPa-10 min.

The semi-dried GP powder at 12% w and a completely dried powder were also weighted and pressed with the same standard parameters: 150° C.-20 MPa-10 min. Samples in the shape of discs were obtained with enough mechanical properties to be handled and are tested for their physical properties. The results are reported in table 1.

TABLE 1

| | Density | Hardness | Young Modulus |
|---|---|---|---|
| | (g/cm3) | (HV) | (GPa) |
| GP Reference | 2.08 ± 0.01 | 86 ± 6 | 36.4 ± 2.0 |
| 12% wt residual | | | |
| humidity | | | |
| GP full dry + | 2.09 ± 0.01 | 92 ± 6 | 36.8 ± 0.4 |
| 12% water | | | |
| GP full dry + | 2.11 ± 0.01 | 124 ± 7 | 41.8 ± 0.1 |
| 9% water | | | |
| GP full dry + | 2.12 ± 0.02 | 105 ± 15 | 42.6 ± 2.3 |
| 6% water | | | |
| GP full dry + | 1.86 ± 0.02 | 135 ± 8 | 19.4 ± 5.4 |
| 3% water | | | |
| GP full dry | / | Fragile material | Fragile material |
| | | Not evaluable | Not evaluable |

In FIG. 2 the pictures of the sample discs so obtained are shown: FIG. 2 a) shows the disc samples obtained with the re-wetted dry GP powder at 12% w and 9% w humidity, they show good mechanical properties and are compact and without cracks; FIG. 2 b) shows a disc sample obtained with the re-wetted dry GP powder at 6% w humidity, it has inferior mechanical properties and shows cracks; FIG. 2 c) shows a disc sample obtained with the re-wetted dry GP powder at 3% w humidity, it is apparently without cracks but the mechanical properties show that the consolidation with a full chemical reaction has not taken place. The not re-wetted sample disc in FIG. 2 d) is a so fragile material, which is not evaluable.

The results in table 1 and in FIG. 2 are clear evidence of what follows:
The water present in the geopolymer can be tuned trough a like-reversible process;
It is evident how it is required a minimum water amount to ensure a good components properties and integrity;
A humidity value of 6% could seem good, but the disc are very fragile;
Similar results for 9 and 12% wt of re-wetted humidity were obtained using a geopolymer with a residual humidity in the range 0%<x<6% and adding water to reach a humidity of 9 and 12% wt.

### Example 2—Binders Obtained by Salt Addition

A humidity value of 9% is used for a comparative study of re-wetting the fully dried GP powder (labelled GP25) using hydrated salt addition in place of liquid water addition and operating as in Example 1, in order to compare the resulting mechanical properties using the optimal humidity condition as inferred from Table 1.

GP powder was dried overnight at 150° C. to have total drying. Measured weight loss was 12% wt. The amount of salt added to each sample of dry GP25 powder was calculated to match the water content of 9%. A semi-dried 9% w humidity sample (not re-wetted) is used for comparison. The GP25 humid and re-wetted powders are pressed in samples having the shape of discs as in example 1.

The salts tested are listed as follows in Table 2, together with the final evaluation of eligibility thereof:

TABLE 2

| | |
|---|---|
| AlN3O9*9H2O - Aluminium nitrate | No OK |
| nonahydrate, | |
| H5N*NaO4P*4H2O - Ammonium Phosphate | No OK |
| dibasic tetrahydrate, | |
| CNa2O3•10H20 - Sodium Carbonate | OK |
| decahydrate (Scharlau) | |
| Na2PO4•12H2O - Sodium phosphate | NOK |
| dibasic dodecahydrate | |
| Na3PO4•12H2O - Sodium phosphate | OK |
| tribasic dodecahydrate (ChemLab) | |
| Na2SO4•10H2O - Sodium sulfate | |
| decahydrate (Honeywell - Fluka) OK | |
| Na2B4O7•10H2O - di-Sodium | OK* |
| tetraborate dehydrate (Scharlau) | |

(*) not to be used for Safety reason

The mechanical properties of the sample discs are reported in table 3

TABLE 3

| | Salt | | | | Young |
|---|---|---|---|---|---|
| | density | Umidity | Density | Hardness | Modulus |
| Sample name | (g/cm3) | (%) | (g/cm3) | (HV) | (Gpa) |
| GP - Reference | — | 9% | 2.10 ± 0.01 | 124.3 ± 6.6 | 41.1 ± 2.1 |
| dryGP25 + | 1.44 | 9% | 2.08 ± 0.02 | 114 ± 26.2 | 36.0 ± 2.5 |
| Na₂CO₃•10H₂0 | | | | | |
| dryGP25 + | 1.62 | 9% | 2.12 ± 0.01 | 121.5 ± 9.1 | 41.5 ± 0.7 |
| Na₃PO₄•12H₂O | | | | | |
| dryGP25 + | 1.46 | 9% | 2.13 ± 0.04 | 121.8 ± 31.7 | 43.0 ± 1.4 |
| Na₂SO₄•10H₂O | | | | | |

As it is clearly shown by comparison of table 1 and 3, the re-wetting carried out by addition of salts give similar or even better results compared to the benchmark (GP25 reference) and to re-hydration with water.

### Example 3—Production of Brake Pads

A number of identical brake pads 1 are produced using the apparatus or plant 2 schematically shown in FIG. 1, the components of which are chosen of laboratory scale. Identical friction material formulations were prepared, using for each component the average value of the intervals reported in table 4, below, and using as binder, indicated as “binder mix”, powders obtained according to examples 1 and 2 at different degrees of humidity; the GP powders only partially dried and having a humidity of 10% wt after production and grinding are used as benchmark references A and B, and the GP powder totally or almost totally dried and then re-hydrated at different moisture content by using either liquid water or hydrated salts are compared with the benchmark references.

TABLE 4

| Component | Geopolymeric Mix |
|---|---|
| Materials | % Vol |
| Fibers | 8-25 |
| Friction Powders | 0.5-3 |
| Carbon | 8-20 |
| Rubbers | 1-4 |
| Medium Abrasive | 5-15 |
| Mild Abrasive | 9-12 |
| Sulphurs | 3-10 |
| Inorganic Binder Mix | 20-60 |
| TOTAL | 100 |

The binder mix is added to the other ingredients of the mix according to a general scheme: binder 20-60% in weight, other components 40-80% in weight; the mix is done with a Loedige mixer. The system (geopolymer+water) is the 47% wt of the friction mix.

Subsequently, the friction material mixes/compounds so obtained are molded in identical brake pads, placing the raw or “green” compound and a metallic support into one mold. Molding takes place by steps at temperatures of 100-150/70-135/70-135° C., subjecting the raw compound to a molding pressure of 250-720 Kg/cm2 for a time of 2-15 minutes.

The friction material blocks 27 so obtained are tested for their mechanical properties. The experimental results are reported in form of bar graphics in FIGS. from 3 to 9.

Similarly to the pure matrix (as in EP3841311) studies, it is confirmed how a minimum water amount is required to have the activation of the consolidation.

Compressibility, hardness and density results confirm that in order to have acceptable mechanical characteristics, the humidity amount in the friction material is to be higher than 9% wt, considering the re-wetting approach.

It is shown that for the test samples obtained through the re-wetting approach a higher water amount is required to have the consolidation, compared to the pure matrix samples. The re-wetting approach on friction materials works in the same way, but it gives different (and even better) properties compared to a friction material having the same humidity amount with the humidity already inside the powder after (partial) drying and not added as liquid water on the completely or almost completely dried GP.

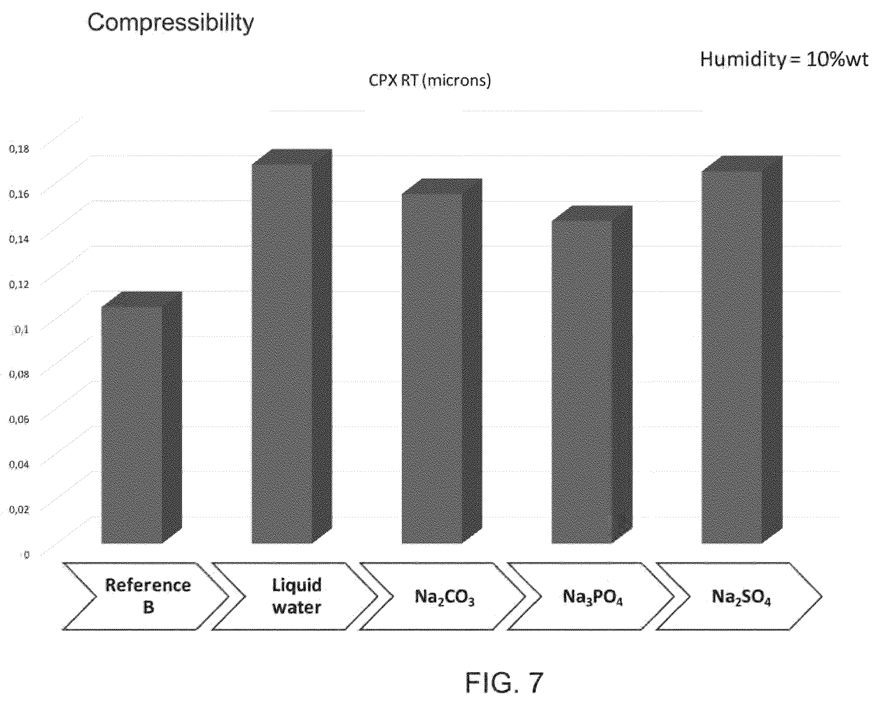

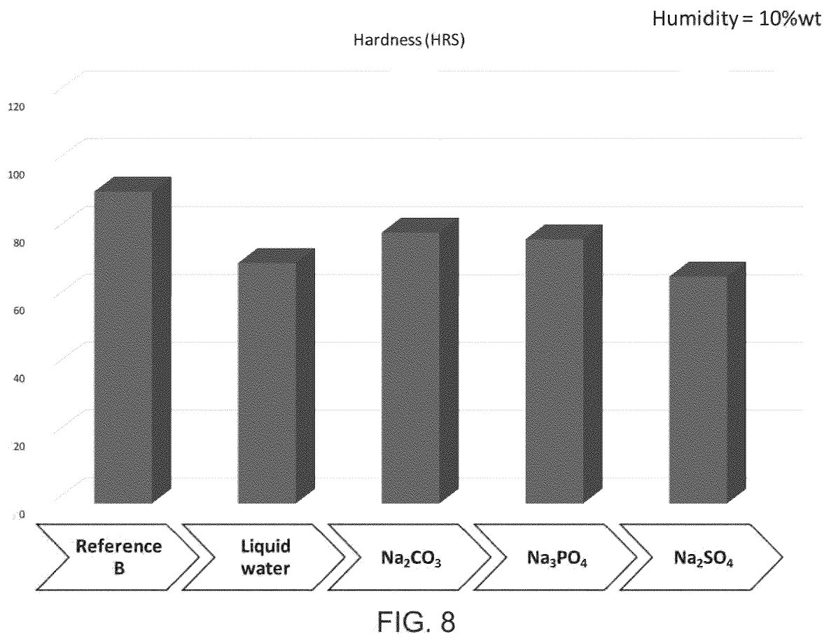

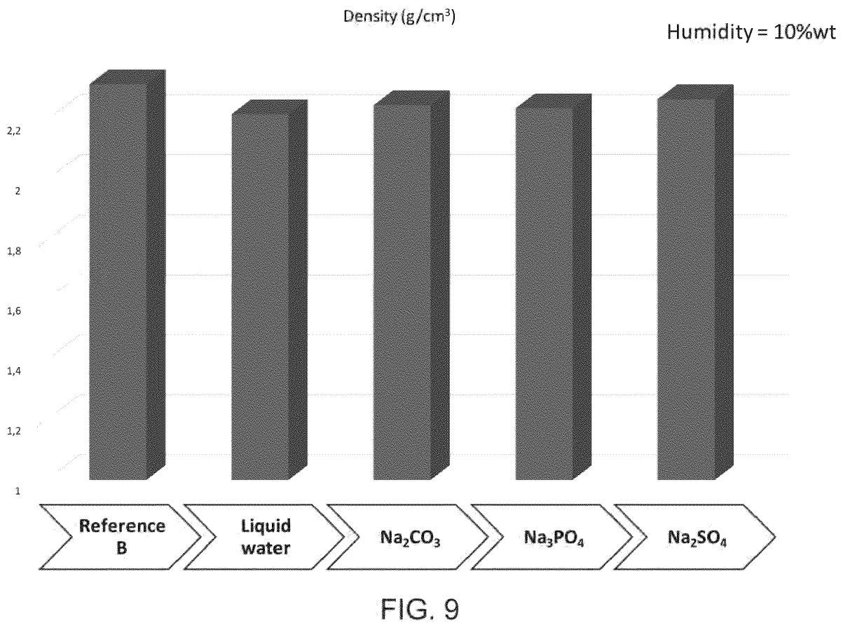

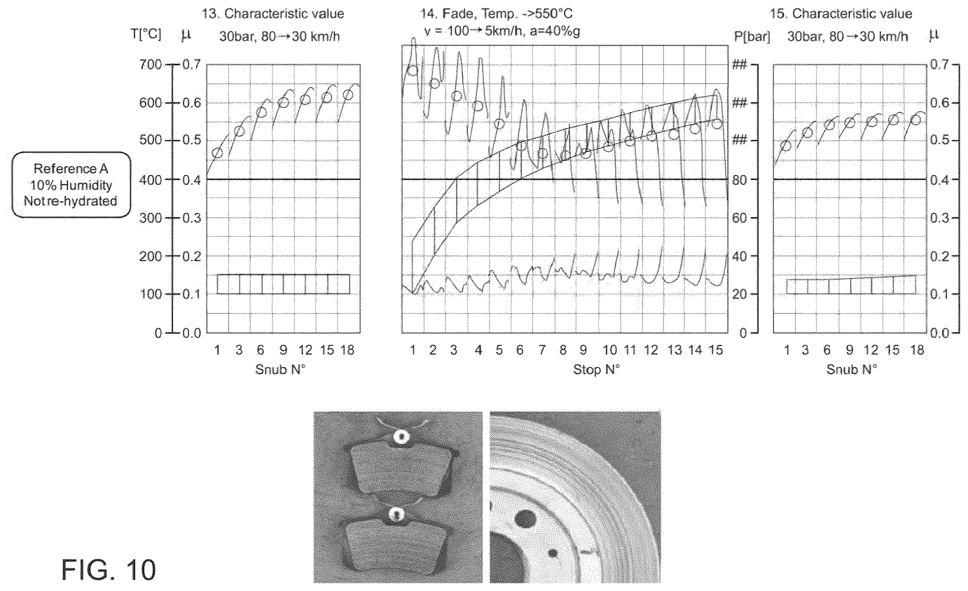

Regarding the re-wetting approach with hydrated salts (FIGS. 7 to 9), a fixed humidity amount of 10% wt had been selected in order to check which salt works better. A second benchmark B was selected also in order to complete the study with the AKM characterization.

The system (geopolymer+water) is the 47% wt of the friction mix. Re-wetting with hydrated salt show properties comparable to those of the re-wetting approach by liquid water, and in some case even better properties.

### Example 4—Braking Tests

The brake pads produced as described in example 3 were subjected to the following tests:

Efficiency Test according to AKM including: settlement braking, braking at different fluid pressures, cold (<50° C.) assessment braking, simulated highway braking, two high-energy braking (first FADE test) series interspersed with a regenerative braking series. From this test it is also possible to extrapolate, using methods known to industry technicians, the wear to which the brake pad and disc are subjected.

An extract of the results obtained is illustrated in FIGS. from 10 to 12, which schematically represent the most significant data of the experimental curves obtained. The graphs are self-explanatory, also thanks to the descriptive labels inserted in the figures.

As can be seen, the experimental AKM results for the braking properties are very similar and completely comparable (when not better, especially for the re-wetting salt approach) with those of the benchmark samples obtained according to EP3841311.

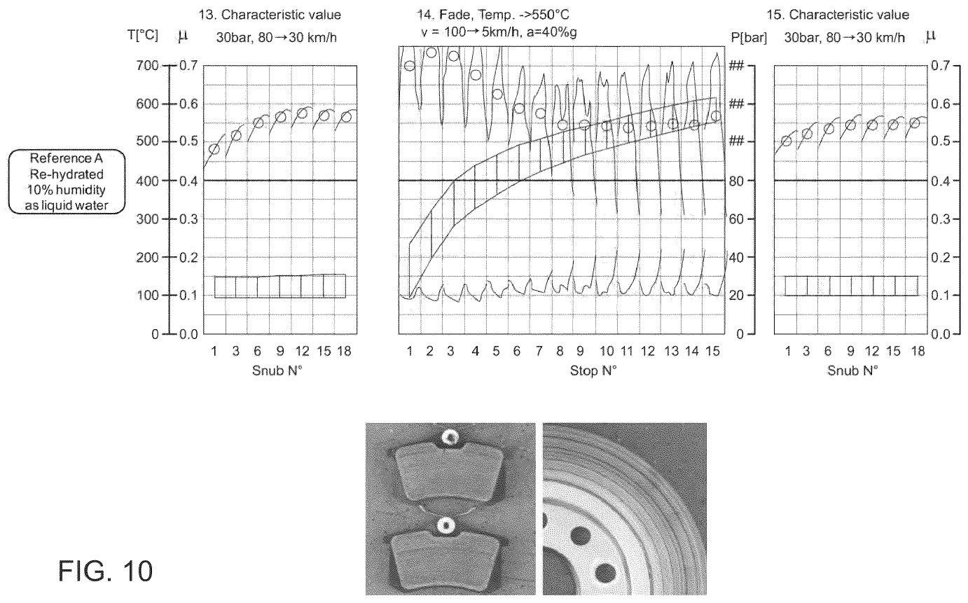

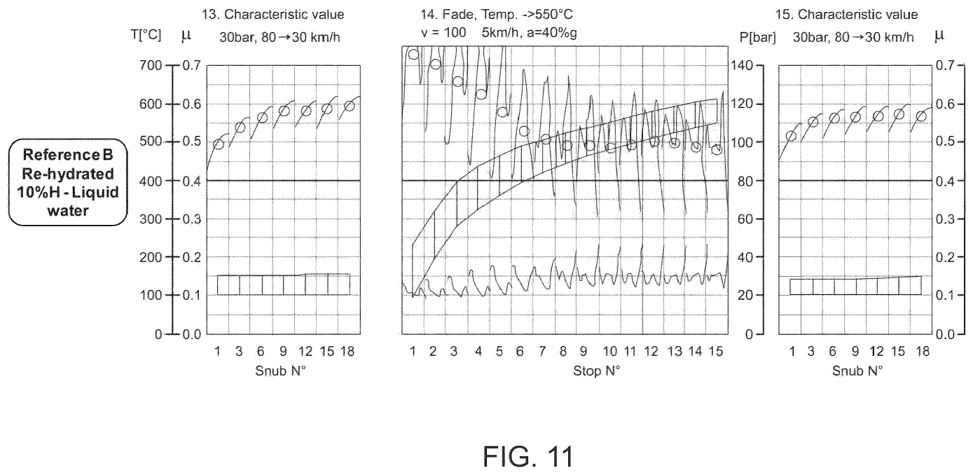

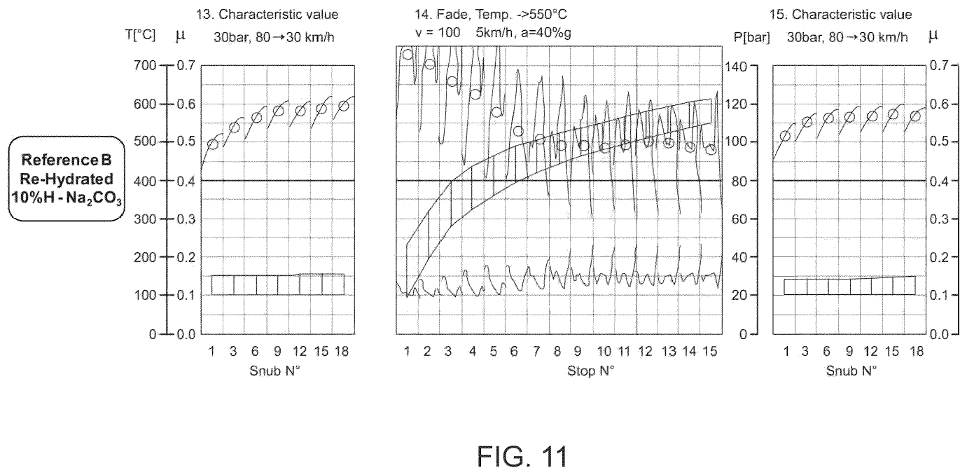

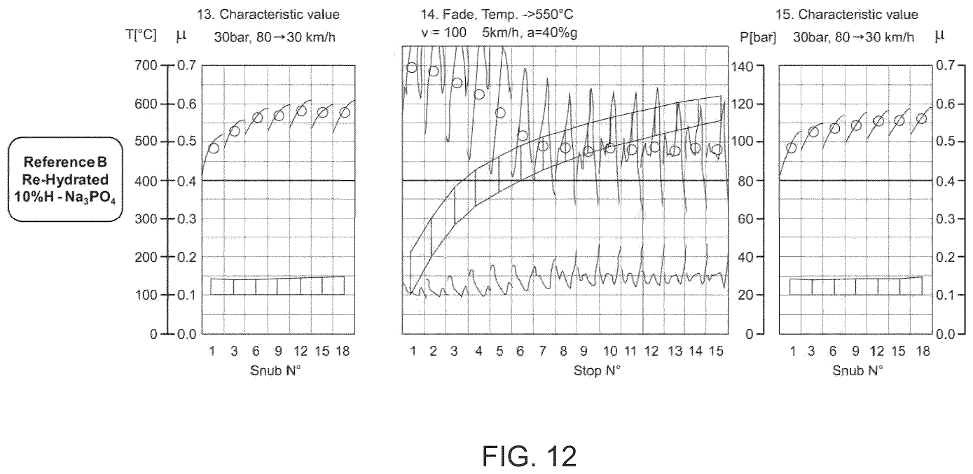

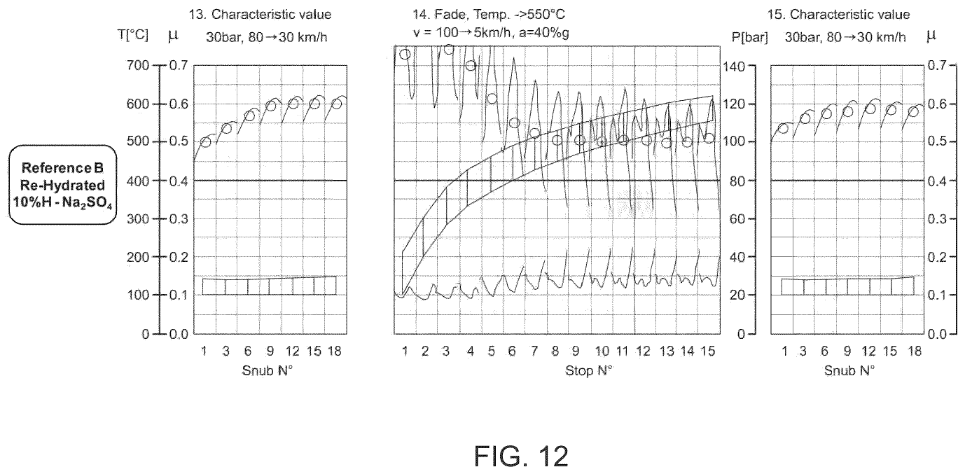

Table 5 below shows the results of a wear comparative test carried out on the materials of FIG. 10.

TABLE 5

| PAD WEAR | | |
|---|---|---|
| Inner | Outer | DISC WEAR |

Reference A
10% Humidity
Not re-hydrated

| | | |
|---|---|---|
| 0.49 mm | 0.43 | 4.8 g |
| 5.8 g | 5.3 | |

Reference A
re-hydrated 10%
Humidity as liquid water

| | | |
|---|---|---|
| 0.58 mm | 0.58 | 6.4 g |
| 4.9 g | 5.3 | |

As it can be seen also the wear is similar to the prior art, even if the pads according to the invention are less subject to a loss of weight, due to a better compactness.

In the end, it may be concluded that the re-wetting approach to reach a desired and precise moisture content in the final friction material is a winning approach: the control of the productive process is fairly better and easier; in case of errors the re-hydrated GP may be recovered in full, by drying it completely and then re-wetting it again. Moreover, a very precise control of moisture content with reproducible results may be obtained, and just in the optimal, restricted range surprisingly discovered, so ensuring more constant braking performances in the various batches of production.

Accordingly, the present invention presents the following advantages:
Possibility to tune the humidity content on the powder owing to a full or partial drying;
Adding in a second step the desired water amount, so as to have lower limitation on the geopolymer powder production and in particular obtaining the humidity control during the process, permitting to always have an acceptable humidity range;
It is a possible to recover the waste eventually derived from production of the geopolymer powder;
The use of liquid water during the friction material production, has the secondary positive effect to reduce the volatile powder of the mix, thanks to the liquid water which maintain the fine powder fraction into the mix.

All the aims of the present invention are therefore fulfilled.

### Certain Terminology

Although certain braking devices, systems, and methods have been disclosed in the context of certain example embodiments, it will be understood by those skilled in the art that the scope of this disclosure extends beyond the specifically disclosed embodiments to other alternative embodiments and/or uses of the embodiments and certain modifications and equivalents thereof, like brake shows for braking systems based on brake drums. Use with any structure is expressly within the scope of this invention. Various features and aspects of the disclosed embodiments can be combined with or substituted for one another in order to form varying modes of the assembly. The scope of this disclosure should not be limited by the particular disclosed embodiments described herein.

Conditional language, such as “can,” “could,” “might,” or “may,” unless specifically stated otherwise, or otherwise understood within the context as used, is generally intended to convey that certain embodiments include or do not include, certain features, elements, and/or steps. Thus, such conditional language is not generally intended to imply that features, elements, and/or steps are in any way required for one or more embodiments.

Unless stated otherwise, the terms “approximately,” “about,” and “substantially” as used herein represent an amount close to the stated amount that still performs a desired function or achieves a desired result. For example, in some embodiments, as the context may dictate, the terms “approximately”, “about”, and “substantially” may refer to an amount that is within less than or equal to 10% of the stated amount. Likewise, the term “generally” as used herein represents a value, amount, or characteristic that predominantly includes or tends toward a particular value, amount, or characteristic.

This disclosure expressly contemplates that various features and aspects of the disclosed embodiments can be combined with, or substituted for, one another. Accordingly, the scope of this disclosure should not be limited by the particular disclosed embodiments described above, but should be determined only by a fair reading of the claims that follow as well as their full scope of equivalents.

1. A method for manufacturing a block or layer of friction material without asbestos and insensitive to heat degradation in use, comprising:
preparing a wet paste formed by mixing an alkaline silicate solution with a material selected in the group consisting of metakaolin, kaolin, fly ash, mixtures thereof, preferably only commercial powder metakaolin, and spreading the wet paste on a support to form a layer or tape which is subsequently subjected to a thermal treatment to form a geopolymer aggregate; wherein:
the thermal treatment consists in drying the wet paste in an oven/furnace to obtain a completely dried or almost completely dried geopolymer aggregate having in any case a moisture content lower than a desired moisture content to be obtained in the geopolymer; and the method further comprises:
grinding the completely dried or almost completely dried geopolymer aggregate to a powder;
re-wetting the completely dried or almost completely dried geopolymer powder to a desired moisture content;
using the ground and re-wetted powder as an inorganic binder in a friction material compound, mixing it with inorganic and/or organic and/or metallic fibers, with at least one friction modifier or lubricant and with at least one filler or abrasive, so as to obtain a raw frictional material compound having as binder almost exclusively or exclusively said ground re-wetted geopolymeric aggregate; and
hot molding between 40° C. and 300° C. the raw friction material compound to obtain a block of friction material having at least 90% geopolymer as binder.

2. The method according to claim 1, wherein re-wetting the completely dried or almost completely dried geopolymer powder to a desired moisture content is performed so as to obtain a final moisture content comprised between 4% w and 16% w calculated on the total weight of the geopolymer binder after re-wetting.

3. The method according to claim 1, wherein re-wetting the completely dried or almost completely dried geopolymer powder to a desired moisture content is carried out by adding to the completely dried or almost completely dried geopolymer powder a pre-established quantity of liquid water.

4. The method according to claim 1, wherein re-wetting the completely dried or almost completely dried geopolymer powder to a desired moisture content is carried out by adding to the completely dried or almost completely dried geopolymer powder a pre-established quantity of an hydrated salt.

5. The method according to claim 4, wherein the hydrated salt is selected in the group consisting of: Sodium or potassium Carbonate decahydrate (e.g. CNa2O3*10H20), Sodium or potassium phosphate tribasic dodecahydrate (e.g. Na3PO4*12H2O), Sodium or potassium sulfate decahydrate (e.g. Na2SO4*10H2O), or any combination thereof.

6. The method according to claim 1, wherein re-wetting the completely dried or almost completely dried geopolymer powder to a desired moisture content is carried out during and together with using the ground and re-wetted powder as an inorganic binder in a friction material compound, mixing it with inorganic and/or organic and/or metallic fibers to obtain said raw frictional material compound having as binder almost exclusively or exclusively said ground re-wetted geopolymeric aggregate.

7. The method according to claim 1, wherein re-wetting the completely dried or almost completely dried geopolymer powder to a desired moisture content is carried out before using the around and re-wetted powder as an inorganic binder in a friction material compound, mixing it with inorganic and/or organic and/or metallic fibers directly on the completely dried or almost completely dried geopolymer powder obtained after grinding the completely dried or almost completely dried geopolymer aggregate to a powder, using a Loedige or Eirich mixer, preferably by adding in the mixer said completely dried or almost completely dried geopolymer powder and a substantial amount of liquid water.

8. A method for obtaining an inorganic binder for asbestos free friction material insensitive to heat degradation during use, comprising:
preparing a wet paste formed by mixing an alkaline silicate solution with a material selected in the group consisting of metakaolin, kaolin, fly ash, mixtures thereof, preferably only commercial powder metakaolin, and spreading the wet paste on a support to form a layer or tape which is subsequently subjected to a thermal treatment to form a geopolymer aggregate; wherein:
the thermal treatment consists in drying the wet paste in an oven/furnace to obtain a completely dried or almost completely dried geopolymer aggregate having in any case a moisture content lower than a desired moisture content to be obtained in the geopolymer; wherein the method further comrises:
grinding the completely dried or almost completely dried geopolymer aggregate to a powder; and
re-wetting the completely dried or almost completely dried geopolymer powder to a desired moisture content, said ground and re-wetted geopolymer aggregate constituting the inorganic binder.

9. (canceled)

10. A brake pad (1) comprising a block (27) of asbestos free friction material including as component materials inorganic and/or organic and/or metallic fibers, at least one binder, at least one friction modifier or lubricant, and at least one filler or abrasive, characterized by the fact that the binder is almost completely or completely and exclusively inorganic, being made up at least 90% of an amorphous geopolymer or a mixture of amorphous geopolymers, wherein the amorphous geopolymer or a mixture of amorphous geopolymers are obtained by:
preparing a wet paste formed by mixing an alkaline silicate solution with a material selected in the group consisting of metakaolin, kaolin, fly ash, mixtures thereof, preferably only commercial powder metakaolin, and spreading the wet paste on a support to form a layer or tape which is subsequently subjected to a thermal treatment to form a geopolymer aggregate; wherein the thermal treatment consists in drying the wet paste in an oven/furnace to obtain a completely dried or almost completely dried geopolymer aggregate having in any case a moisture content lower than a desired moisture content to be obtained in the geopolymer;
grinding the completely dried or almost completely dried geopolymer aggregate to a powder;
re-wetting the completely dried or almost completely dried geopolymer powder to a desired moisture content;
using the ground and re-wetted powder as an inorganic binder in a friction material compound, mixing it with inorganic and/or organic and/or metallic fibers, with at least one friction modifier or lubricant and with at least one filler or abrasive, so as to obtain a raw frictional material compound having as binder almost exclusively or exclusively said ground re-wetted geopolymeric aregate; and
hot molding between 40° C. and 300° C. the raw friction material compound to obtain a block of friction material having at least 90% geopolymer as binder.

11. The brake pad (1) according to claim 10, wherein the block (27) of friction material presents a ratio in volume between the lubricants and abrasives contained in the friction material selected between 1:1 and 1:4.

12. An apparatus or plant (2) for manufacturing brake pads (1) having a block (27) of friction material wherein the binder is almost completely or completely and exclusively inorganic, being made up at least 90% of an amorphous geopolymer or a mixture of amorphous geopolymers; the apparatus or plant (2) comprising:
a first mixer (3), e.g. a Dispersion Mixer, configured to receive and mix a caustic silicate solution (4) in water and metakaolin (5) to obtain a semi-liquid geopolymeric paste or slurry (6);
a tape casting machine (7) configured to cast in form of a layer or tape (8) of substantially uniform thickness a freshly formed geopolymer (6), and to made it to rest on a support (9);
a hot air furnace or oven (12) configured to receive the layer or tape (8) of geopolymeric paste or slurry;
a mill (14) arranged downstream the oven or furnace (12) configured to crush said layer or tape (8) of geopolymeric paste or slurry in a powder (8c) having a prefixed range of granulometry; wherein
said hot air furnace or oven (12) is configured to bring the layer or tape (8) of geopolymeric paste or slurry to a completely or almost completely dried condition (8b);
said mill (14) is configured to receive the dried or almost dried geopolymer (8b) for crushing it in a dried or almost dried geopolymeric powder (8c) of preferably a granulometry comprised between 1 to 100 micron; and
said apparatus (2) further comprises:
at least an humidity detector (18) arranged downstream the oven/furnace (12) configured to detect the humidity of the reacted geopolymer after the oven/furnace (12);
a second mixer (20) arranged downstream the mill (14) and configured to receive the dried or almost dried geopolymer (8b) crushed into a powder (8c) and a prefixed quantity of water, either in the form of liquid water or of an hydrated salt, the second mixer (20) being configured to re-wet the dried or almost dried geopolymer powder (8c) to a precise moisture content equal to or lower than the moisture content the reacted geopolymer (8) has at the exit of the casting machine (7);
the apparatus (2) being configured so as
either said second mixer (20) is configured to further receive all component materials of said friction material; or
said second mixer (20) is configured solely to re-wet the powder (8c) to a prefixed value of humidity either by direct addition of liquid water or by indirect addition of water by means of addition of hydrated salts, the apparatus (2) further comprising a third mixer (20b) arranged downstream the second mixer (20) and configured to receive a re-wetted, precisely hydrated geopolymer (8d) and all other component materials (21) of said friction material;
a molding equipment (26) configured to receive a friction material composition (25) obtained in the second or third mixer to mold it in a friction material block or layer (27) having as a binder solely or almost completely a well consolidate matrix of geopolymer.
